(19) United States
(12) Patent Application Publication
(10) Pub. No.: US 2025/0192150 A1
(43) Pub. Date: Jun. 12, 2025

(54) ANODE FOR AN ALL-SOLID-STATE BATTERY AND AN ALL-SOLID-STATE BATTERY INCLUDING THE SAME

(71) Applicants: HYUNDAI MOTOR COMPANY, Seoul (KR); KIA CORPORATION, Seoul (KR)

(72) Inventors: Seul Gi Choi, Changwon-si (KR); Gyeong Jun Chung, Daejeon (KR); So Ri Lee, Suwon-si (KR); Seung Hwan Moon, Hwaseong-si (KR); Ju Yeon Lee, Busan (KR); Jong Jung Kim, Suwon-si (KR)

(73) Assignees: HYUNDAI MOTOR COMPANY, Seoul (KR); KIA CORPORATION, Seoul (KR)

(21) Appl. No.: 18/678,145

(22) Filed: May 30, 2024

(30) Foreign Application Priority Data
Dec. 8, 2023 (KR) 10-2023-0178076

(51) Int. Cl. H01M 4/36; H01M 4/02; H01M 4/133; H01M 4/587; H01M 4/62

(52) U.S. Cl. CPC H01M 4/366; H01M 4/133; H01M 4/587; H01M 4/625; H01M 2004/021; H01M 2004/027

(57) ABSTRACT

An anode for an all-solid-state battery includes a structure with a current collector layer, a first anode active material layer, and a second anode active material layer stacked in order. The first anode active material layer contains a first solid electrolyte, a first anode active material, a first binder, and a dot-shaped first conductive material. The second anode active material layer contains a second solid electrolyte, a second anode active material, a second binder, and a linear second conductive material. An average particle size of the first solid electrolyte is smaller than an average particle size of the second solid electrolyte.

### CROSS-REFERENCE TO RELATED APPLICATION

This application claims the benefit of priority to Korean Patent Application No. 10-2023-0178076, filed in the Korean Intellectual Property Office on Dec. 8, 2023, the entire contents of which are incorporated herein by reference.

### TECHNICAL FIELD

The present disclosure relates to an anode for an all-solid-state battery and an all-solid-state battery including the same.

### BACKGROUND

Various batteries that may overcome limitations of a current lithium secondary battery are being studied in terms of capacity, stability, output, enlargement, ultra-miniaturization, and the like of the battery. Among the battery types, an all-solid-state battery refers to a battery that replaces an electrolyte used in the existing lithium secondary battery with a solid one. The all-solid-state battery does not use a flammable solvent in the battery. Thus, there is no risk of ignition or explosion resulting from a decomposition reaction and the like of the existing electrolyte, thereby greatly improving the battery stability.

Because the all-solid-state battery uses the solid electrolyte, it is difficult for the solid electrolytes to easily penetrate into pores of an active material layer. Accordingly, it is difficult to secure sufficient ionic (e.g., lithium ionic) conductivity in an area adjacent to a current collector layer within the active material layer. In addition, because of the characteristics of the all-solid-state battery of using the solid electrolyte described above, it is difficult to secure sufficient electronic conductivity in an area within the active material layer that is farther away from the current collector layer.

Additionally, to increase an energy density of the all-solid-state battery, research has recently been conducted to apply an anode active material that has a relatively great rate of volume change resulting from operation of the all-solid-state battery. In this case, contact between the solid electrolyte and a conductive material may be lost because of the relatively great volume change rate of the anode active material. This may result in the decrease in the ionic conductivity and the electronic conductivity within an anode of the all-solid-state battery.

### SUMMARY

The present disclosure has been made to solve the above-mentioned problems occurring in the prior art while advantages achieved by the prior art are maintained.

An aspect of the present disclosure provides an anode for an all-solid-state battery that may solve the above-described problems.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, an anode for an all-solid-state battery includes a structure with a current collector layer, a first anode active material layer, and a second anode active material layer stacked in order. The first anode active material layer contains a first solid electrolyte, a first anode active material, a first binder, and a dot-shaped first conductive material. The second anode active material layer contains a second solid electrolyte, a second anode active material, a second binder, and a linear second conductive material. An average particle size (D50) of the first solid electrolyte is smaller than an average particle size (D50) of the second solid electrolyte.

According to another aspect of the present disclosure, an all-solid-state battery includes the anode for the all-solid-state battery described above, a cathode for an all-solid-state battery, and a solid electrolyte layer interposed between the cathode for the all-solid-state battery and the anode for the all-solid-state battery.

### DETAILED DESCRIPTION

Hereinafter, an anode for an all-solid-state battery and an all-solid-state battery including the same are described in detail such that those having ordinary skill in the art may practice the same.

### Anode for All-Solid-State Battery

The anode for the all-solid-state battery of the present disclosure includes a structure in which a current collector layer, a first anode active material layer, and a second anode active material layer are stacked in order.

### Current Collector Layer

A type and a shape of the current collector layer are not particularly limited as long as the current collector layer is conductive without causing a chemical change in the all-solid-state battery.

For example, the current collector layer may contain copper, stainless steel, aluminum, nickel, titanium, calcined carbon, copper or stainless steel surface-treated with carbon, nickel, titanium, silver, and the like, and/or an aluminum-cadmium alloy. The current collector may have various forms such as a film, a sheet, a foil, a net, a porous body, a foam, a non-woven fabric, and the like.

### First Anode Active Material Layer

The first anode active material layer may include a first anode active material, a first binder, a first solid electrolyte, and a first conductive material.

A type of the first anode active material may not be particularly limited, and various types of known anode active materials commonly used for the anode for the all-solid-state battery may be used without a limitation.

In one embodiment, the first anode active material may include at least a silicon-based anode active material. The silicon-based anode active material may have a relatively high theoretical capacity, and therefore, the all-solid-state battery to which the first anode active material including the same is applied may have high capacity and energy density.

A type of the first binder may not be particularly limited, and various types of known binders commonly used for the anode for the all-solid-state battery may be used without a limitation. For example, as the first binder, an acryl-based binder, a polyvinylidene fluoride (PVDF)-based binder, a polytetrafluoroethylene (PTFE)-based binder, or a butadiene rubber-based binder such as nitrile butadiene rubber (NBR) may be used.

A type of the first solid electrolyte may not be particularly limited, and various types of known solid electrolytes commonly used for the anode for the all-solid-state battery may be used without a limitation. For example, as the first solid electrolyte, one selected from a group comprising or consisting of a sulfide-based solid electrolyte, an oxide-based solid electrolyte, a polymer solid electrolyte, or any combination thereof may be used.

In one embodiment, the first solid electrolyte in the first anode active material layer may exist in a form of particles. In this regard, the first solid electrolyte in the form of particles may serve to provide a transfer path for ions (e.g., lithium ions) by filling a space between the first conductive material, the first binder, and the first anode active material.

In one implementation, the first solid electrolyte may have a smaller average particle size (D50) than a second solid electrolyte contained in the second anode active material layer, which is described below. In this case, the first solid electrolyte, which has the relatively small average particle size, more effectively fills the space between the first conductive material, the first binder, and the first anode active material. Thus, a porosity within the first anode active material layer may be relatively lowered. Accordingly, the sufficient ion transfer path may be secured within the first anode active material layer disposed adjacent to the current collector layer.

In one implementation, the average particle size (D50) of the first solid electrolyte may be in a range from 0.5 to 2.0 μm, and in one example may be from 0.8 to 1.5 μm. When the average particle size (D50) of the first solid electrolyte satisfies the above-mentioned numerical range, as the first solid electrolyte forms an optimal network in the space between the first conductive material, the first binder, and the first anode active material, the ion transfer path may be formed more effectively. Accordingly, the first anode active material layer disposed adjacent to the current collector layer may have very excellent ionic conductivity.

The first conductive material may be a dot-shaped conductive material. In this regard, the dot-shaped conductive material may mean a conductive material that is substantially spherical or oval or has a shape similar thereto and thus has a relatively small Brunauer-Emmett-Teller (BET) specific surface area.

In this regard, when the first conductive material is the dot-shaped conductive material, a content of the first conductive material may be relatively reduced and a content of the first binder may be relatively increased on a surface of the first anode active material layer facing the current collector layer. As such, as the content of the first binder on the surface of the first anode active material layer facing the current collector layer increases, an adhesion between the current collector layer and the first anode active material layer may be improved.

In one implementation, the BET specific surface area of the first conductive material may be in a range from 50 to 100 m²/g, and in one example may be from 65 to 80 m²/g. When the BET specific surface area of the first conductive material satisfies the above-mentioned numerical range, as the content of the first binder is optimized on the surface of the first anode active material layer facing the current collector layer, the adhesion between the current collector layer and the first anode active material layer may become very excellent.

In one implementation, the first conductive material may have an average aspect ratio (i.e., a converted length of the conductive material divided by a width of a cross-section perpendicular to a longitudinal direction of the material) of equal to or higher than 2 and equal to or lower than 10. In some examples, the average aspect ratio may be equal to or higher than 2.5, equal to or higher than 3, equal to or higher than 3.5, or equal to or higher than 4, and may be equal to or lower than 9.5, equal to or lower than 9, equal to or lower than 8.5, equal to or lower than 8, equal to or lower than 7.5, or equal to or lower than 7. In this regard, when the average aspect ratio of the first conductive material satisfies the above-mentioned numerical range, as the content of the first binder is optimized on the surface of the first anode active material layer facing the current collector layer, the adhesion between the current collector layer and the first anode active material layer may become very excellent. When the average aspect ratio of the first conductive material is too high, a rate of contact with the conductive material in the first anode active material layer increases, which may increase a probability f a side reaction occurring at a conductive material-electrolyte interface within an electrode.

In one example, an electron microscope photograph (magnification: 1,000 times) may be taken for a cross-section (unit area: 2*10⁻² mm²) of the anode active material layer for 10 randomly selected first conductive materials. In such a case, the above-mentioned average aspect ratio refers to an average of values obtained by dividing respective lengths (in a case of a curved conductive material, a converted length when extended in a straight line) by the width of the cross-section perpendicular to the longitudinal direction.

In one implementation, the first conductive material may contain at least one selected from a group comprising or consisting of carbon black, Ketjen black, acetylene black, crystalline carbon, or any combination thereof.

### Second Anode Active Material Layer

The second anode active material layer may include a second anode active material, a second binder, the second solid electrolyte, and a second conductive material.

A type of the second anode active material may not be particularly limited. Various types of known anode active materials commonly used for the anode for the all-solid-state battery may be used without a limitation.

In this case, the second anode active material may include at least the silicon-based anode active material like the first anode active material. When the silicon-based anode active material having the relatively high theoretical capacity is used as the second anode active material, the all-solid-state battery to which the second anode active material is applied may have high capacity and energy density.

A type of the second binder may not be particularly limited, and various types of known binders commonly used for the anode for the all-solid-state battery may be used without a limitation. For example, as the second binder, the acryl-based binder, the polyvinylidene fluoride (PVDF)-based binder, the polytetrafluoroethylene (PTFE)-based binder, or the butadiene rubber-based binder such as nitrile butadiene rubber (NBR) may be used. In this case, the second binder may be the same as or different from the first binder.

A type of the second solid electrolyte may not be particularly limited, and various types of known solid electrolytes commonly used for the anode for the all-solid-state battery may be used without a limitation. For example, as the second solid electrolyte, one selected from a group comprising or consisting of the sulfide-based solid electrolyte, the oxide-based solid electrolyte, the polymer solid electrolyte, or any combination thereof may be used. In this case, the second solid electrolyte may be the same as or different from the first solid electrolyte.

In one implementation, the second solid electrolyte in the second anode active material layer may exist in a form of particles. In this regard, the second solid electrolyte in the form of particles may serve to provide a transfer path for ions by filling a space between the second conductive material, the second binder, and the second anode active material.

In one implementation, the second solid electrolyte may have the greater average particle size (D50) than the first solid electrolyte. In this case, the second solid electrolyte with the relatively great average particle size may have high resistance to moisture introduced from the outside, and thus may compensate for moisture vulnerability derived from the first solid electrolyte with the relatively small average particle size.

In one implementation, the average particle size (D50) of the second solid electrolyte may be in a range from 2.5 to 4.5 μm, and in one example may be from 2.9 to 4.3 μm. When the average particle size (D50) of the second solid electrolyte satisfies the above-mentioned numerical range, while effectively performing the role of compensating for the moisture vulnerability described above, the second solid electrolyte may effectively fill the space the second conductive material, the second binder, and the second anode active material. Thus, the sufficient ion transfer path may be provided.

The second conductive material may be a linear conductive material. In this regard, the linear conductive a conductive material that has a material may mean substantially straight or curved fibrous form or a shape similar thereto and thus has a relatively great BET specific surface area.

In this regard, the second conductive material may serve to provide a transfer path for electrons within the second anode active material layer. In this case, when the second conductive material is the linear conductive material as described above, entanglement, contact, or the like between the second conductive materials may occur even in an area relatively far from the current collector layer. Accordingly, the transfer path for the electrons within the second anode active material layer may be effectively provided.

In addition, even when a volume change rate of the second anode active material is relatively great, such as when the second anode active material includes the silicon-based anode active material, the linear second conductive material may effectively accept the volume change of the second anode active material. Accordingly, lifespan characteristics of the all-solid-state battery may be improved.

In one implementation, the BET specific surface area of the second conductive material may be in a range from 180 to 300 m²/g, and in one example may be from 200 to 250 m²/g. When the BET specific surface area of the second conductive material satisfies the above-mentioned numerical range, while electronic conductivity in the second anode active material layer may be excellent as the electron transfer path is sufficiently provided within the second anode active material layer, the second conductive material may effectively accept the volume change of the second anode active material.

In one implementation, the second conductive material may have an average aspect ratio of equal to or higher than 50 and equal to or lower than 100. In some examples, the average aspect ratio may be equal to or higher than 55, equal to or higher than 58, or equal to or higher than 60, and equal to or lower than 95, equal to or lower than 90, equal to or lower than 85, equal to or lower than 80, equal to or lower than 75, or equal to or lower than 70. In one example, the second conductive material may have an average length in a range from 5 to 50 μm. In this regard, when the average aspect ratio and/or the average length of the second conductive material satisfies the above-mentioned numerical range, while the electronic conductivity in the second anode active material layer may be very excellent as the electron transfer path is sufficiently provided within the second anode active material layer, the second conductive material may effectively accept the volume change of the second anode active material. In particular, because porosity of the second anode active material layer is greater than that of the first anode active material layer described above, by applying the second conductive material with the higher average aspect ratio to the second anode active material layer, an appropriate contact rate and a high conductivity may be secured because of thin and long morphological characteristics of the second conductive material.

In one implementation, the second conductive material may contain a carbon nanotube (e.g., at least one selected from a group comprising or consisting of a single-walled carbon nanotube, a double-walled carbon nanotube, a multi-walled carbon nanotube, or any combination thereof) or a carbon nanofiber.

### Stacked Structure of current Collector Layer, First Anode Active Material Layer, and Second Anode Active Material Layer

The anode for the all-solid-state battery of the present disclosure has the stacked structure of the current collector layer, the first anode active material layer, and the second anode active material layer.

In this regard, as described above, in the first anode active material layer adjacent to the current collector layer, the dot-shaped first conductive material may play the role in improving the adhesion with the current collector layer. Also, the first solid electrolyte having the relatively small average particle size may play the role in securing the ionic conductivity in the area adjacent to the current collector layer.

In addition, as described above, in the second anode active material layer spaced apart from the current collector layer, the linear second conductive material may play the role in securing the electronic conductivity in the area far from the current collector layer and in accepting the volume expansion of the second anode active material. Also, the second solid electrolyte having the relatively great average particle size may play the role in securing the resistance to the moisture.

In this case, in one implementation, a thickness T2 of the second anode active material layer may be greater than a thickness T1 of the first anode active material layer. In one example, the first anode active material layer may have the thickness in a range from 20 to 40 μm, and the second anode active material layer may have the thickness in a range from 50 to 70 μm.

Specifically, the thickness T2 of the second anode active material layer and the thickness T1 of the first anode active material layer may satisfy Formulas 1 and 2 below.

The first anode active material layer using the small-diameter solid electrolyte has the smaller porosity than the second anode active material layer. Thus, when prepared with the same composition and composition ratio as the second anode active material layer, the first anode active material layer may be desirable to have the thickness smaller than that of the second anode active material layer. When the thickness of the second anode active material layer is appropriately greater than the first anode active material layer and a T1/(T1+T2) value is equal to or smaller than 0.5, stability against moisture may be effectively secured. Also, when the T1/(T1+T2) value is equal to or greater than 0.25, all of the advantages of the first anode active material layer and the second anode active material layer may be appropriately secured.

$$0. 25 \leq T 1 / ( T 1 + T 2 ) \leq 0.5 \qquad Formula 1$$

$$70 μm \leq T 1 + T 2 \leq 110 μm \qquad Formula 2$$

### All-Solid-State Battery

The all-solid-state battery of the present disclosure may include the anode for the all-solid-state battery described above. More specifically, the all-solid-state battery may include the anode for the all-solid-state battery, a cathode for the all-solid-state battery, and a solid electrolyte layer interposed between the cathode for the all-solid-state battery and the anode for the all-solid-state battery.

In this regard, types of the cathode for the all-solid-state battery and the solid electrolyte layer may not be particularly limited. Various types of known cathodes and solid electrolyte layers commonly used for the all-solid-state battery may be used without a limitation.

Hereinafter, the present disclosure is described in more detail via Examples. However, such Examples are only intended to help understand the present disclosure. The scope of the present disclosure is not limited to such Examples in any way.

### Preparation Examples 1-7: Preparation of Anode for All-Solid-State Battery

A mixture was prepared by dry mixing the first anode active material (a silicon-graphite composite (Si—G)), the first solid electrolyte, and the first conductive material with each other using a mixer. The prepared mixture was put into a solvent along with the first binder (a rubber-based binder solution) and a dispersant and mixed using the mixer. The mixture was then coated on the current collector and dried sufficiently at 90° C. to form the first anode active material layer.

Thereafter, a mixture was prepared by dry mixing the second anode active material (the silicon-graphite composite (Si—G)), the second solid electrolyte, and the second conductive material with each other using the mixer. The prepared mixture was put into the solvent along with the second binder (the rubber-based binder solution) and the dispersant and mixed using the mixer. The mixture was then coated on the first anode active material layer and sufficiently dried at 90° C. Thereafter, the resulting product was heated at 120° C. for 4 hours to prepare the anode for the all-solid-state battery including the stacked structure of the current collector layer, the first anode active material layer (thickness: 30 μm), and the second anode active material layer (thickness: 60 μm).

In each of Preparation Examples 1-7, the first solid electrolyte, the first conductive material, the second solid electrolyte, and the second binder as shown in Table 1 below were used.

TABLE 1

| | Average particle | | | | BET specific | | |
|---|---|---|---|---|---|---|---|
| | size (D50) of solid | | Type of conductive | | surface area of | | |
| | electrolyte | | material | | conductive material | | |
| | First | Second | First | Second | First | | Second |
| | solid | solid | conductive | conductive | conductive | | conductive |
| | electrolyte | electrolyte | material | material | material | | material |
| Preparation | 1.0 μm | 3.3 μm | Carbon | CNT | 70 | m²/g | 200 m²/g |
| Example 1 | | | black | | | | |
| Preparation | 1.0 μm | 3.3 μm | Carbon | Carbon | 70 | m²/g | 100 m²/g |
| Example 2 | | | black | black | | | |
| Preparation | 1.0 μm | 3.3 μm | CNT | CNT | 150 | m²/g | 200 m²/g |
| Example 3 | | | | | | | |
| Preparation | 3.3 μm | 3.3 μm | Carbon | CNT | 70 | m²/g | 200 m²/g |
| Example 4 | | | black | | | | |
| Preparation | 1.0 μm | 1.0 μm | Carbon | CNT | 70 | m²/g | 200 m²/g |
| Example 5 | | | black | | | | |
| Preparation | 3.3 μm | 3.3 μm | Carbon | Carbon | 70 | m²/g | 100 m²/g |
| Example 6 | | | black | black | | | |
| Preparation | 3.3 μm | 1.0 μm | Carbon | CNT | 70 | m²/g | 200 m²/g |
| Example 7 | | | black | | | | |

1) Aspect ratio of carbon black: 5
2) Aspect ratio of carbon nanotubes (CNT): 60 to 70
3) Average length of linear conductive material (CNT): 10 μm

### Example 1: All-Solid-State Battery

Using the anode for the all-solid-state battery prepared based on Preparation Example 1 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 1: All-Solid-State Battery

Using the anode for the all-solid-state battery prepared based on Preparation Example 2 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 2: All-Solid-State Battery

Using the anode for the all-solid-state battery prepared based on Preparation Example 3 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 3: All-Solid-State Battery

Using the anode for the all-solid-state battery prepared based on Preparation Example 4 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 4: All-Solid-State Battery

Using the anode for the all-solid-state battery prepared based on Preparation Example 5 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 5: All-Solid-State Battery

Using the anode for the all-solid-state battery prepared based on Preparation Example 6 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Comparative Example 6: All-Solid-State Battery

Using the anode for the all-solid-state battery prepared based on Preparation Example 7 described above, the all-solid-state battery including the anode for the all-solid-state battery, the cathode for the all-solid-state battery, and the solid electrolyte layer interposed between the anode for the all-solid-state battery and the cathode for the all-solid-state battery was manufactured.

### Experimental Example: Evaluation of Characteristics of All-Solid-State Battery

A 0.05C discharge capacity and direct current internal resistance (DC-IR) were measured for the all-solid-state batteries of Example 1 and Comparative Examples 1-6, and the results are shown in Table 2. A specific measurement method is as described in a measurement method below.

TABLE 2

| | 0.05 C discharge capacity | DC-IR |
|---|---|---|
| Example 1 | 185 mAh/g | 10.3Ω |
| Comparative | 170 mAh/g | 12.5Ω |
| Example 1 | | |
| Comparative | 172 mAh/g | 12.5Ω |
| Example 2 | | |
| Comparative | 175 mAh/g | 12.0Ω |
| Example 3 | | |
| Comparative | 165 mAh/g | 13.0Ω |
| Example 4 | | |
| Comparative | 170 mAh/g | 12.5Ω |
| Example 5 | | |
| Comparative | 167 mAh/g | 12.5Ω |
| Example 6 | | |

### Measurement Method

### 0.05C Discharge Capacity Measurement Method

A 0.05 C reference capacity was calculated for 20 hours of discharge based on a cathode half-cell reference capacity, and then a current value based on an amount of a cathode active material in each of the Example and Comparative Examples was calculated, applied, and measured using the 0.05 C reference capacity. Specifically, the all-solid-state batteries manufactured in the Example and Comparative Examples were charged with a current of 0.05 C until a voltage reached 4.3 V, and after cutoff at an upper limit voltage, were discharged with the current of 0.05 C until the voltage reached 2.5 V to measure discharge capacities.

### DC-IR Measurement Method

The DC-IR was measured as follows. The all-solid-state batteries were charged at a constant current of 0.05 C in a first cycle, then rested, were discharged to a state of charge (SOC) 50% at the same current, and then rested again for a certain period of time. Thereafter, a high current pulse 5 times or more the current value of 0.05 C was injected, and a voltage change between the rest state and the high current pulse injected state was measured to calculate a resistance based on the same and the current value was calculated using Ohm's law.

Referring to Table 2, it was identified that: the all-solid-state battery of Comparative Example 1 using the carbon black with a relatively small BET specific surface area as the second conductive material; the all-solid-state battery of Comparative Example 2 using the CNT with a relatively high BET specific surface area as the first conductive material; the all-solid-state battery of Comparative Example 3 using one with a relatively great average particle size as the first solid electrolyte; the all-solid-state battery of Comparative Example 4 using one with a relatively small average particle size as the second solid electrolyte; the all-solid-state battery of Comparative Example 5 using one with a relatively great average particle size as the first solid electrolyte and the carbon black with a relatively small BET specific surface area as the second conductive material; and the all-solid-state battery of Comparative Example 6 using one with a relatively great average particle size as the first solid electrolyte and one with a relatively small average particle size as the second solid electrolyte are inferior to the all-solid-state battery of Example 1 in both the 0.05 C discharge capacity and the DC-IR characteristics.

The first anode active material layer in the present disclosure is the active material layer disposed adjacent to the current collector layer. In the first anode active material first conductive material with the layer, the dot-shaped relatively small BET specific surface area may serve to improve the adhesion with the current collector layer. Also, the first solid electrolyte with the relatively small average particle size may serve to secure the ionic conductivity in the area adjacent to the current collector layer.

In addition, the second anode active material layer in the present disclosure is the active material layer disposed spaced apart from the current collector layer with the first anode active material layer interposed therebetween. In the second anode active material layer, the linear second conductive material with the relatively great BET specific surface area may serve to secure the electronic conductivity in the area far from the current collector layer and to accept the volume expansion of the second anode active material. Also, the second solid electrolyte with the relatively great average particle size may serve to secure the resistance to the moisture.

The anode for the all-solid-state battery in the present disclosure may have the stacked structure in which the current collector layer, the first anode active material layer, and the second anode active material layer are sequentially stacked. In this regard, as the components contained in each of the first anode active material layer and the second anode active material layer within the stacked structure perform the above-described roles, the anode for the all-solid-state battery may exhibit excellent stability and excellent charge and discharge efficiency.

Hereinabove, although the present disclosure has been described with reference to embodiments, the present disclosure is not limited thereto. The embodiments may be variously modified and altered by those having ordinary skill in the art to which the present disclosure pertains without departing from the spirit and scope of the present disclosure claimed in the following claims.

What is claimed is:

1. An anode for an all-solid-state battery, the anode comprising:
a structure with a current collector layer;
a first anode active material layer; and
a second anode active material layer stacked in order,
wherein the first anode active material layer contains a first solid electrolyte, a first anode active material, a first binder, and a dot-shaped first conductive material,
wherein the second anode active material layer contains a second solid electrolyte, a second anode active material, a second binder, and a linear second conductive material, and
wherein an average particle size (D50) of the first solid electrolyte is smaller than an average particle size (D50) of the second solid electrolyte.

2. The anode of claim 1, wherein the average particle size (D50) of the first solid electrolyte is in a range from 0.5 to 2.0 μm, and wherein the average particle size (D50) of the second solid electrolyte is in a range from 2.5 to 4.5 μm.

3. The anode of claim 1, wherein each of the first solid electrolyte and the second solid electrolyte independently comprises a sulfide-based solid electrolyte, an oxide-based solid electrolyte, a polymer solid electrolyte, or any combination thereof.

4. The anode of claim 1, wherein a Brunauer-Emmett-Teller (BET) specific surface area of the first conductive material is in a range from 50 to 100 m²/g, and wherein a BET specific surface area of the second conductive material is in a range from 180 to 300 m²/g.

5. The anode of claim 1, wherein the first conductive material comprises carbon black, Ketjen black, acetylene black, crystalline carbon, or any combination thereof.

6. The anode of claim 1, wherein the second conductive material contains a carbon nanotube or a carbon nanofiber.

7. The anode of claim 6, wherein the carbon nanotube comprises a single-walled carbon nanotube, a double-walled carbon nanotube, a multi-walled carbon nanotube, or any combination thereof.

8. The anode of claim 1, wherein an average aspect ratio of the first conductive material is equal to or higher than 2 and equal to or lower than 10, and wherein an average aspect ratio of the second conductive material is equal to or higher than 50 and equal to or lower than 100.

9. The anode of claim 1, wherein an average length of the second conductive material is in a range from 5 to 50 μm.

10. The anode of claim 1, wherein each of the first anode active material and the second anode active material includes a silicon-based anode active material.

11. The anode of claim 1, wherein a thickness T2 of the second anode active material layer is greater than a thickness T1 of the first anode active material layer.

12. The anode of claim 11, wherein the thickness T2 of the second anode active material layer and the thickness T1 of the first anode active material layer satisfy Formulas 1 and 2 below:
$$0.25 \leq T 1 / ( T 1 + T 2 ) \leq 0.5 ; and \qquad Formula 1$$
$$70 μm \leq T 1 + T 2 \leq 110 μm . \qquad Formula 2$$

13. An all-solid-state battery comprising:
the anode for the all-solid-state battery of claim 1;
a cathode for an all-solid-state battery; and
a solid electrolyte layer interposed between the cathode for the all-solid-state battery and the anode for the all-solid-state battery.
